(19) United States
(12) Patent Application Publication
(10) Pub. No.: US 2014/0059356 A1
(43) Pub. Date: Feb. 27, 2014

(54) TECHNIQUE FOR RECONFIGURABLE DATA STORAGE MEDIA ENCRYPTION

(71) Applicant: Iron Mountain Incorporated, Boston, MA (US)

(72) Inventor: Geoffrey Nesnow, Warwick, RI (US)

(21) Appl. No.: 13/917,997

(22) Filed: Jun. 14, 2013

Related U.S. Application Data
(60) Provisional application No. 61/692,915, filed on Aug. 24, 2012.

(51) Int. Cl. G06F 21/60

(52) U.S. Cl. CPC G06F 21/602
USPC 713/189

(57) ABSTRACT

A technique for managing encryption keys includes encrypting the contents of a piece of media with a first encryption key, encrypting the first encryption key with a second encryption key, and storing the encrypted first encryption key on or in connection with the piece of media. Encrypted data may be recovered by receiving the encrypted first encryption key from the piece of media, receiving the second encryption key (e.g., from a user to whom the key is assigned), recovering the first encryption key using the second encryption key, and decrypting the data from the piece of media using the first encryption key.

### CROSS-REFERENCE TO RELATED APPLICATIONS

This application claims the benefit of U.S. provisional patent application No. 61/692,915, filed Aug. 24, 2012, the teachings and contents of which are hereby incorporated by reference in their entirety.

### BACKGROUND

The contents of data storage media, such as tapes, optical disks, and the like, are sometimes encrypted to provide a safeguard against unauthorized persons accessing such contents. Encryption is typically performed through the use of a cryptographic algorithm and an encryption key. Data to be stored on media (e.g., plain text) are processed by the cryptographic algorithm using the encryption key to produce encrypted data (e.g., ciphertext), and the encrypted data are written onto the media. Anyone with access to the media having the encryption key and the cryptographic algorithm can decrypt the encrypted material to reveal the original contents.

Where media are stored at storage facilities, the operators of the storage facilities may manage numerous keys for numerous customers. In a typical scenario, encryption keys are handed out to owners of media and to others authorized to access their contents.

### SUMMARY

Although there is a widespread need to encrypt the contents of storage media, encryption is often avoided because of difficulties involved in managing encryption keys. Unfortunately, conventional options for managing encryption keys have involved risks of data loss or of compromise, such as when encryption keys fall into the hands of malicious persons.

For example, a media storage facility storing media accessible to many authorized persons may distribute encryption keys to all such persons. However, distributing keys increases the risk that the keys will fall into malicious hands, such that malicious persons may access and decrypt media contents. Alternatively, the facility may keep the encryption keys at a central location, such that only a single person can manage the keys. This option is more secure, but it creates a great deal of dependency on the person and system managing the keys. For example, in a disaster situation, the person managing the keys may be unavailable and/or the only copies of the keys may be destroyed. The contents of the media may thus become unrecoverable.

Electronic key management systems have been implemented to address these concerns, but such systems are not without their own deficiencies. For example, electronic key management systems may be difficult to manage over time, as software revisions, computers, networks, and operating systems are updated, and as critical personnel are changed. Electronic systems that work well initially may thus tend to degrade as time passes, such that they become unavailable at some point or may become available but only after long delays and/or substantial efforts by personnel acting under pressure to recover the data.

In contrast with these prior approaches, an improved technique for managing encryption keys includes encrypting the contents of a piece of media with a first encryption key, encrypting the first encryption key with a second encryption key, and storing the encrypted first encryption key on or in connection with the piece of media. The second encryption key is distributed to one or more persons authorized to access the piece of media. Anyone having the second encryption key and access to the piece of media can apply the second encryption key to the encrypted first encryption key stored on or in connection with the piece of media to recover the first encryption key. The recovered first encryption key may then be applied to decrypt the contents of the piece of media and recover its contents.

On some schedule and/or in response to events, such as a suspected theft or compromise of the second encryption key, the second key may be changed to a different value. Each time the second encryption key is changed, the encrypted first encryption key stored on or in connection with the piece of media is updated to reflect the value of the first encryption key encrypted by the new second encryption key. The previous value of the encrypted first encryption key may be deleted.

The encrypted first encryption key may be stored in connection with the piece of media in any suitable form. In one example, the encrypted first encryption key is written to the piece of media itself at a designated re-writable location. The encrypted first encryption key can thus be readily changed by replacing the contents of the re-writable location with the value of the first encryption key encrypted with the new second encryption key. In another example, the encrypted first encryption key is placed on a barcode or other identifier (e.g., an RFID) affixed to or otherwise placed in relation to the piece of media such that the identifier is associated with the piece of media. The encrypted first encryption key can thus be readily changed by replacing the barcode or other ID with a new one, which reflects the value of the first encryption key encrypted with the new second encryption key. The encrypted first encryption key thus has the advantageous feature that it can be changed easily quickly, in as little as seconds. In an example, the first encryption key is closely protected, such that there is rarely if ever any need to re-encrypt that data stored on the piece of media.

With the improved technique, the second encryption key can be distributed to authorized persons as widely as desired and updated regularly and readily, without placing the contents of the media at excessive risk. Old copies of second encryption keys will no longer work once corresponding encrypted first encryption keys are removed from the media. Management of encryption keys is thus greatly simplified.

Certain embodiments are directed to a method of managing encryption keys for data stored on data storage media. The method includes obtaining a set of data, encrypting the set of data with a first encryption key to generate a set of encrypted data, and encrypting the first encryption key with a second encryption key to generate an encrypted first encryption key. The method further includes storing the set of encrypted data on a piece of data storage media and storing the encrypted first encryption key on or in connection with the piece of data storage media.

Other embodiments are directed to a method of managing encryption keys for data stored on data storage media. The method includes reading a set of encrypted data from a piece of media, the set of encrypted data being an encrypted version of a set of data, and receiving an encrypted first encryption key stored on or in connection with the piece of media. The encrypted first encryption key is an encrypted version of a first encryption key. The method further includes decrypting the encrypted first encryption key using a second encryption key to recover the first encryption key and decrypting the set of encrypted data using the first encryption key to recover the set of data.

Further embodiments are directed to computerized apparatus and computer program products. Some embodiments involve activity that is performed at a single location, while other embodiments involve activity that is distributed over a computerized environment (e.g., over a network).

### BRIEF DESCRIPTION OF THE SEVERAL VIEWS OF THE DRAWINGS

The foregoing and other features and advantages will be apparent from the following description of particular embodiments of the invention, as illustrated in the accompanying drawings, in which like reference characters refer to the same parts throughout the different views. In the accompanying drawings,

FIG. 1 is a block diagram of an example computing system adapted to operate in accordance with the improved techniques disclosed herein;

FIG. 2 is a data flow diagram showing an example generation of encrypted data and an encrypted encryption key according to the method of FIG. 2;

FIG. 3 is a data flow diagram showing an example data flow for decrypting the encrypted data encrypted using the data flow shown in FIG. 2;

FIG. 4 is a flowchart of an example process for managing encryption keys for encrypted pieces of media;

FIG. 5 is a flowchart showing an example process for decrypting encrypted data;

FIG. 6 is a data flow diagram showing an example generation of sub-keys of the second encryption key shown in FIGS. 2 and 3;

FIG. 7 is a data flow diagram showing an example data flow for recovering the second encryption key from the sub-keys shown in FIG. 6;

FIG. 8 is a data flow diagram showing an example generation of multiple encrypted first encryption keys through the use of multiple respective second encryption keys; and

FIG. 9 is a data flow diagram showing an example data flow for decrypting encrypted data using any of the multiple second encryption keys of FIG. 8.

### DETAILED DESCRIPTION OF THE INVENTION

Embodiments of the invention will now be described. It is understood that such embodiments are provided by way of example to illustrate various features and principles of the invention, and that the invention hereof is broader than the specific example embodiments disclosed.

An improved technique for managing encryption keys includes encrypting the contents of a piece of media with a first encryption key, encrypting the first encryption key with a second encryption key, and storing the encrypted first encryption key on or in connection with the piece of media.

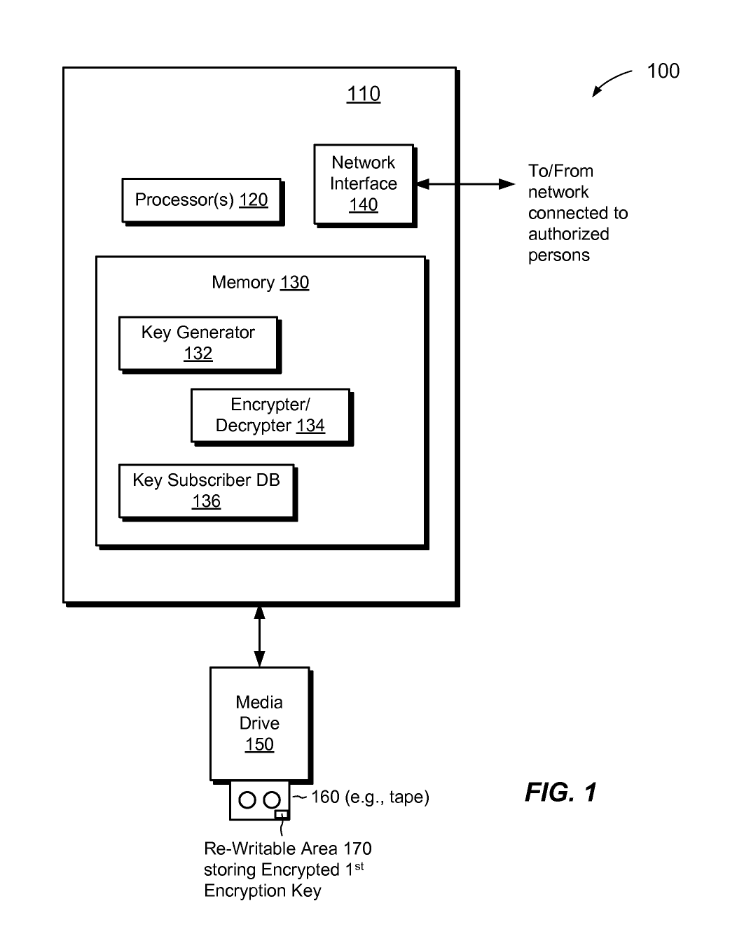

FIG. 1 shows an example electronic system 100 in which the improved technique hereof may be practiced. The electronic system 100 includes a computerized apparatus 110 and a media drive 150. The computerized apparatus 110 may be implemented in a variety of forms, such as with a desktop computer, laptop computer, server, tablet, or smartphone, for example. The media drive 150 may be a tape drive, an optical drive, some other type of media drive, or any combination of media drives.

The computerized apparatus 110 is seen to include a set of processors 120 (e.g., one or more processing chips and/or assemblies), a network interface 140, such as a network interface card (NIC), and memory 130. The memory 130 includes both volatile memory (e.g., RAM) and non-volatile memory, such as one or more disk drives, solid state drives (SSDs) and the like. The set of processors 120, the memory 130, and the network interface 140 together form a specialized circuit, which is constructed and arranged to carry out various operations as described herein. For example, the memory 130 stores executable instructions. When the executable instructions are run by the set of processors 120, the set of processors 120 are made to carry out various processes and functions, as described herein.

As shown in FIG. 1, the memory 130 includes a key generator 132, an encrypter/decrypter 134, and a key subscriber database 136. In an example, the key generator 132 operates in response to requests from an administrator or other user to generate first encryption keys and second encryption keys. The key generator 132 may generate encryption keys in any suitable manner, such as through the use of a random number generator and/or set of hash functions, for example. In an example, first encryption keys and second encryption keys are each 128-bit values; however, a greater or fewer number of bits may be used depending on the degree of protection desired, and the first encryption keys and second encryption keys need not be the same size. The encrypter/decrypter 134 includes one or more cryptographic algorithms, which each receive as input an encryption key and a set of data to be encrypted or decrypted. In an example, the encryption operations performed by the encrypter/decrypter 134 are reversible, such that any encrypted data may be recovered (decrypted) using the same key and encryption algorithm as were used to encrypt the data. The key subscriber database 136 includes a list of persons (e.g., individual humans and/or organizations) to which second keys are assigned and to which updated values of second keys may be sent.

In an example, the media drive 150 is a tape drive. Pieces of media from storage, such as a tape 160, can be loaded into the media drive 150 for reading and writing. In an example, the tape 160 has a re-writable location 170, e.g., a location on the tape 160 which can be re-written numerous times and is easily and quickly accessible after the tape 160 is loaded into the media drive 150. In an example, the re-writable location 170 is a section of tape provided at the beginning of the tape 160 or at some other readily accessible location. In some examples, certain tapes, including some LTO (Linear Tape Organization) tapes, are not directly re-writable but must be scratched (erased) first before they can be written to again. Such tapes may be provided with a separate region (a re-writable location), which need not be separately erased and re-written via distinct processes, but may instead be overwritten directly. Although a single re-writable location 170 is shown, it is understood that tapes (or other media) may have any number of re-writable locations 170. As will be described, the re-writable location 170 stores one or more encrypted first encryption keys.

In operation, the computerized apparatus 110 receives, e.g., via the network interface 140, a set of data to be encrypted and stored on a piece of media, such as on the tape 160. The computerized apparatus 110 generates, e.g., via the key generator 132, a first encryption key and a second encryption key. The computerized apparatus 110, e.g., via the encrypter/decrypter 134, encrypts the set of data using the first encryption key and encrypts the first encryption key using the second encryption key, thereby generating an encrypted first encryption key. The computerized apparatus 110 directs the media drive 150 to store the set of encrypted data onto the tape 160, and further directs the media drive 150 to write the value of the encrypted first encryption key to the re-writable location 170. The tape 160 may then be placed in storage, e.g., on a shelf of a tape vaulting facility, for later access. The computerized apparatus 110 may send the second encryption key to the person or persons authorized to access the set of data, e.g., by referring to the key subscriber database 136.

At some later time, a user in possession of the second encryption key may obtain the tape 160, load the tape 160 into the media drive 150, and direct the computerized apparatus 110 to read the encrypted data from the tape 160. The computerized apparatus 110 also reads the previously stored encrypted first encryption key from the re-writable location 170. The user enters the second encryption key (e.g., via a user interface—not shown), and the computerized apparatus 110 applies the second encryption key to decrypt the encrypted first encryption key (e.g., via the encrypter/decrypter 134). The computerized apparatus 110 thus recovers the first encryption key, which the computerized apparatus 110 applies to a decryption algorithm to decrypt the set of encrypted data stored on the tape 160. The user may then access the decrypted data.

In some examples, two different electronic systems are provided, a first system 100 as shown in FIG. 1 and a second system like the system 100 but excluding the key generator 132 and the key subscriber database 136. The first system is provided at a site where media are created (e.g., at a customer site), and the second system is provided at the storage facility. Significantly, the second system does not need to store any encryption keys and preferably avoids storing any such keys. The second system receives second encryption keys from users but holds them only temporarily, solely for the purpose of decrypting the encrypted first encryption keys read from locations 170 of media. First encryption keys are similarly held for the limited purpose of decrypting the data from the piece of media. The second system thus preferably holds encryption keys only temporarily, e.g., in volatile memory, and deletes them once decryption is complete. With this arrangement, malicious users have greatly reduced access to keys at the storage facility.

As shown and described, the encrypted first encryption key is stored in the re-writable location 170. However, this is merely an example. Encrypted first encryption keys may be stored on or in connection with media in any suitable form. For example, the encrypted first encryption key may be placed on a barcode label or other identifier (e.g., an RFID) affixed to or otherwise placed in relation to the piece of media such that the identifier is associated with the piece of media. For example, an identifier may be placed on a container that holds the tape 160. Identifiers can be readily changed by replacing them with new ones whenever corresponding second keys are changed.

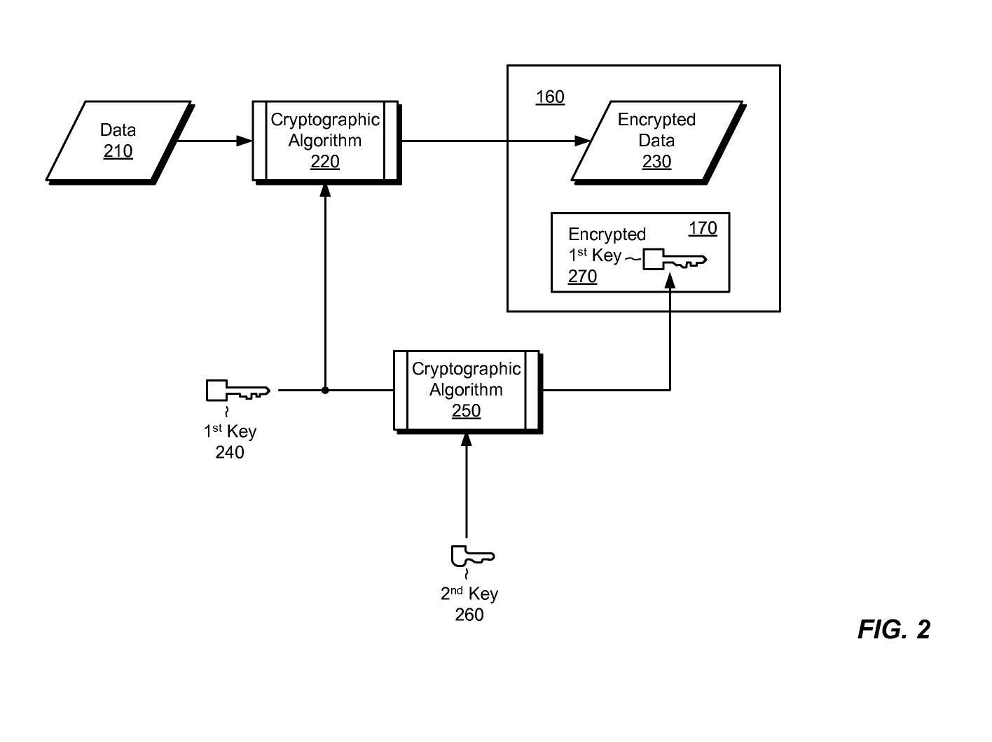

FIG. 2 shows an example data flow for encrypting data on media according to the techniques disclosed herein. The illustrated data flow takes place, for example, in the electronic system 100, which may be provided at the customer site. A set of data 210, which may for example be plaintext data and may be received by the electronic system 100, is input to a first cryptographic algorithm 220 along with a first encryption key 240. The first cryptographic algorithm 220 generates a set of encrypted data 230, which may for example be ciphertext data. The set of encrypted data 230 is then stored on a piece of media, e.g., on the tape 160 by operation of the media drive 150. Also, the first encryption key 240 is input to a second cryptographic algorithm 250 along with a second encryption key 260. The second cryptographic algorithm 250 generates an encrypted first encryption key 270, which is an encrypted version of the first encryption key 240. Although the first and second cryptographic algorithms 220 and 250 are shown as different algorithms, they may alternatively be the same. The encrypted first encryption key 270 is stored on or in connection with the piece of media, for example, in the re-writable location 170 on the tape 160, on a barcode label, RFID, or other identifier. The tape 160 may then be placed in storage, e.g., on a shelf at a tape vaulting facility.

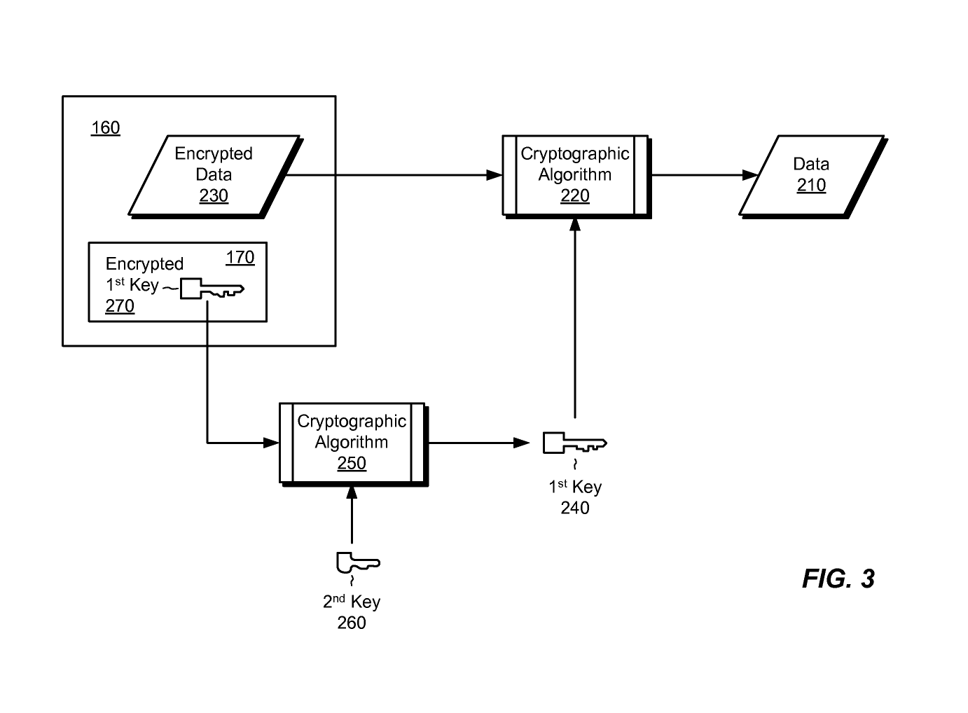

FIG. 3 shows an example data flow for decrypting data stored on media according to the techniques disclosed herein. The illustrated data flow takes place, for example, in an electronic system 100, or in a similar system which may be provided at the storage facility. Here, for example, a user has retrieved the tape 160 from storage and has loaded the tape 160 into the media drive 150 of the electronic system 100. The encrypted first encryption key 270 is obtained and input to the second cryptographic algorithm 250 along with the second key 260, which is obtained from the user. The second cryptographic algorithm 250 receives these inputs and processes them to recover the first encryption key 240. The first encryption key 240 is then applied to the first cryptographic algorithm 220 along with the set of encrypted data 230. The first cryptographic algorithm 220 receives these inputs and processes them to recover the original set of data 210.

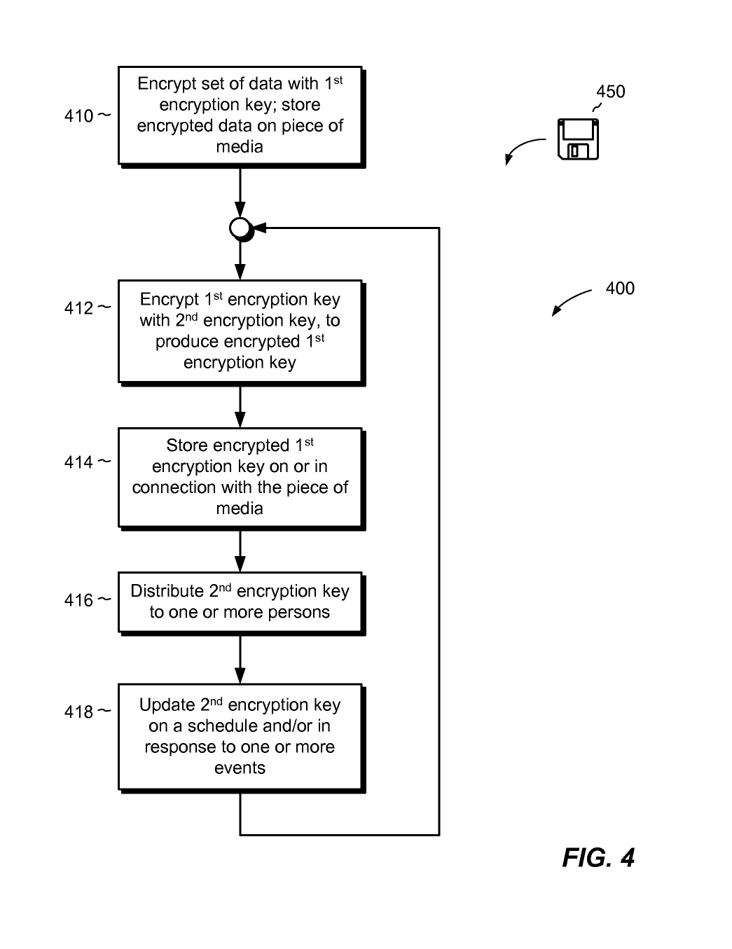

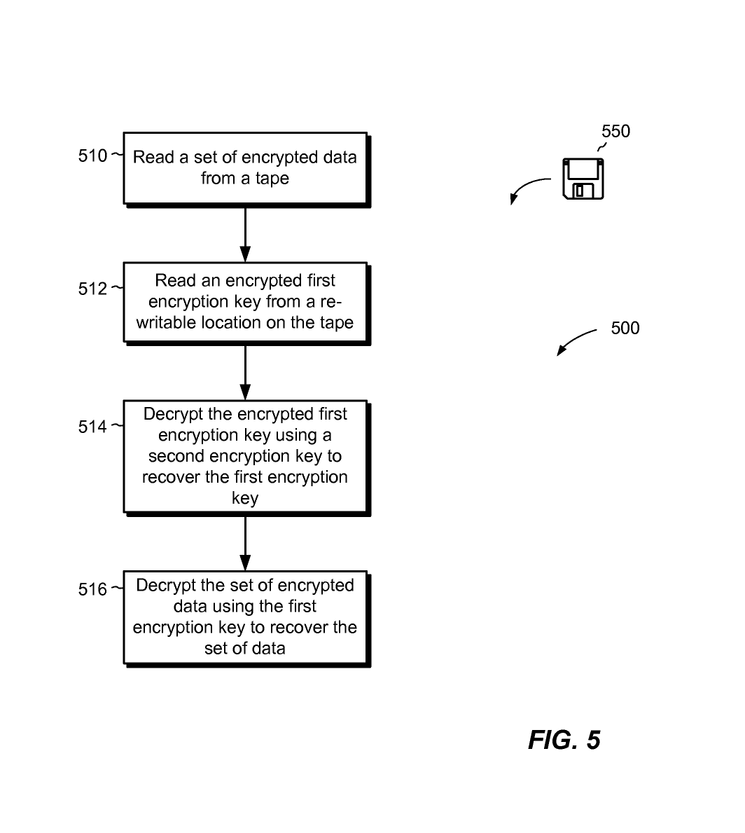

FIGS. 4-5 show example processes 400 and 500 that may be carried out in accordance with improvements hereof. The processes 400 and 500 may be performed by or in connection with the electronic system 100. The various acts of the processes 400 and 500 may be ordered in any suitable way. Accordingly, embodiments may be constructed in which acts are performed in orders different from those illustrated, which may include performing some acts simultaneously, even though the acts are shown as sequential in the figures.

FIG. 4 shows and example process 400 for encrypting a set of data in accordance with the techniques hereof. The process 400 may be performed, for example, at a customer site, at the site of a third party provider working of the customer, or at some other site.

At step 410, a set of data are encrypted using a first encryption key and the resulting set of encrypted data are stored on a piece of media. For example, the encrypter/decrypter 134 of the computerized apparatus 110 applies the first encryption key 240 and the set of data 210 to the first cryptographic algorithm 220 and directs the media drive 150 to write the resulting set of encrypted data 230 to the tape 160.

At step 412, the first encryption key is itself encrypted using a second encryption key, to produce an encrypted first encryption key. For example, the encrypter/decrypter 134 of the computerized apparatus 110 applies the second encryption key 260 and the first encryption key 240 to the second cryptographic algorithm 250. The second cryptographic algorithm 250 generates the encrypted first encryption key 270, which is an encrypted version of the first encryption key 240.

At step 414, the encrypted first encryption key is stored on or in connection with the piece of media. For example, the media drive 150 stores the value of the encrypted first encryption key 270 at the re-writeable location 170 of the tape 160. Alternatively, the computerized apparatus can print a barcode label or generate some other identifier (e.g., an RFID), and a human user, robot, or mechanical apparatus is directed to apply the barcode or other identifier to the piece of media, to its packaging, or to other associated elements.

At step 416, the second encryption key is distributed to one or more persons. For example, the key subscriber database 136 maintains a list of each person (human, group, organization, etc.) authorized to access each piece of media for which an encrypted first encryption key 270 has been created. The key subscriber database 136 sends a copy of the second encryption key 260 to each such person. The key subscriber database 136 may send the second key 260 by encrypted email, postal service, secure web service, or any other suitable means. At the conclusion of step 416, any person in possession of the second key 260 with physical access to the piece of media tagged with the corresponding encrypted first encryption key 270 (i.e., one that is encrypted using the second key 260), may use an electronic system 100 to decrypt the contents stored on the piece of media.

Step 418 is typically conducted sometime later. On some schedule and/or in response to one or more events, the second encryption key is updated. For example, a particular company may have a policy of updating the second key(s) 260 for its media held in storage on some regular basis, such as once per month. Each time a new second encryption key 260 is produced for a piece of media, the computerized apparatus generates a new encrypted first encryption key 270 (step 412), which is stored on or in connection with the piece of media (step 414). The previous value of the encrypted first encryption key 270 is deleted. For instance, if a tape 160 stores the encrypted first encryption key 270 in the re-writable location 170 of the tape 160, the new value of the encrypted first encryption key 270 replaces the old value, such that the old value is removed. If the encrypted first encryption key 270 is provided in the form of a barcode label or RFID, such barcode label or RFID may be removed and physically destroyed. Deleting or destroying any old versions of the encrypted first encryption key 270 prevents malicious users in possession of old second encryption keys 260 from accessing the data 210 on the media. The above-described updates to the second encryption key 260 and encrypted first encryption key 270 may also be conducted in response to events, such as actual or suspected theft or disclosure of a second encryption key.

A clear benefit of the improved technique hereof is thus that keys may be changed very quickly in response to a perceived threat to the security of the data 210, simply by generating a new second encryption key 260, tagging the media with a new encrypted first encryption key 270, and ensuring that the previous encrypted first encryption key 270 is destroyed. It is almost never necessary to re-encrypt the original data 210 (e.g., with a new first encryption key 240), since the value of the first encryption key 240 is closely protected and inaccessible to users.

Companies or other entities may manage their media in a variety of ways. In some examples, a different value of the first encryption key 240 may be used for encrypting data on each piece of media. In this arrangement, entities may find it convenient to provide a copy of the same second encryption key 260 to all persons requiring access to the media. Entities using this approach may employ physical measures to ensure that users' identities are carefully checked before granting them access to media, as anyone with the second encryption key 260 can unlock any piece of media tagged with an encrypted first encryption key 270 generated using the second encryption key 260.

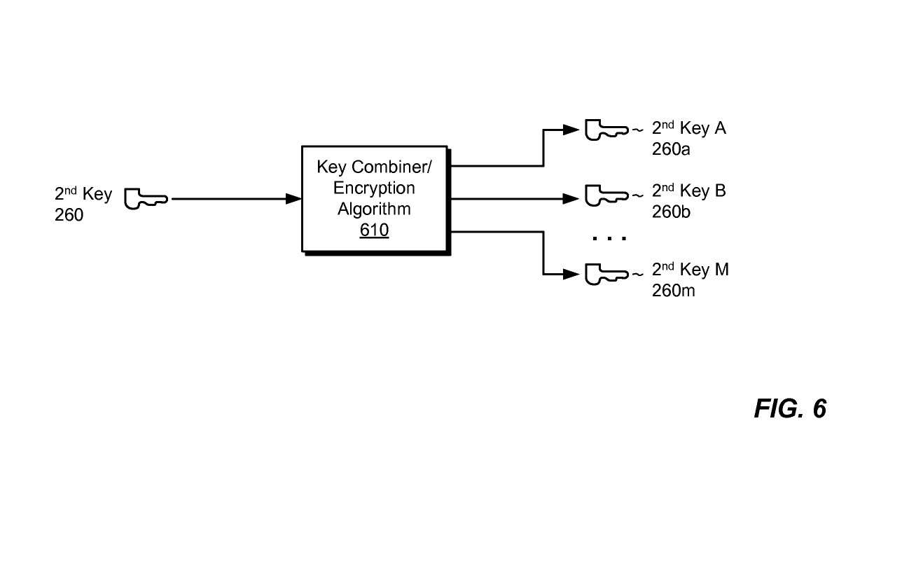

FIG. 6 shows a variant on the above-described technique for managing encryption keys. Here, a key combiner/encryption algorithm 610 receives a second encryption key 260 and generates multiple sub-keys 260a through 260m. Three sub-keys are shown; however, any number may be used. In example usage, the different sub-keys 260a-260m are distributed to different persons. Acting alone, none of the persons has the complete second encryption key 260 and thus none of the persons can unlock the piece of media. Acting together, however, all such persons may submit their respective sub-keys 260a-260m to reconstitute the second encryption key 260 and thus to unlock the piece of media.

The key combiner/encryption algorithm 610 may be arbitrarily simple or complex. In a simple example, the key combiner/encryption algorithm 610 separates the second encryption key 260 into smaller sub-keys. For example, the key combiner/encryption algorithm 610 may divide a 128-bit second encryption key 260 into four 32-bit sub-keys. In a more complex example, the key combiner/encryption algorithm 610 performs an encryption operation on the second encryption key 260, and the resulting encrypted key is separated into the sub-keys 260a-m. In any case, the sub-keys 260a-m are distributed to different persons, who must act together to reconstitute the complete second encryption key 260 and thereby to unlock the piece of media.

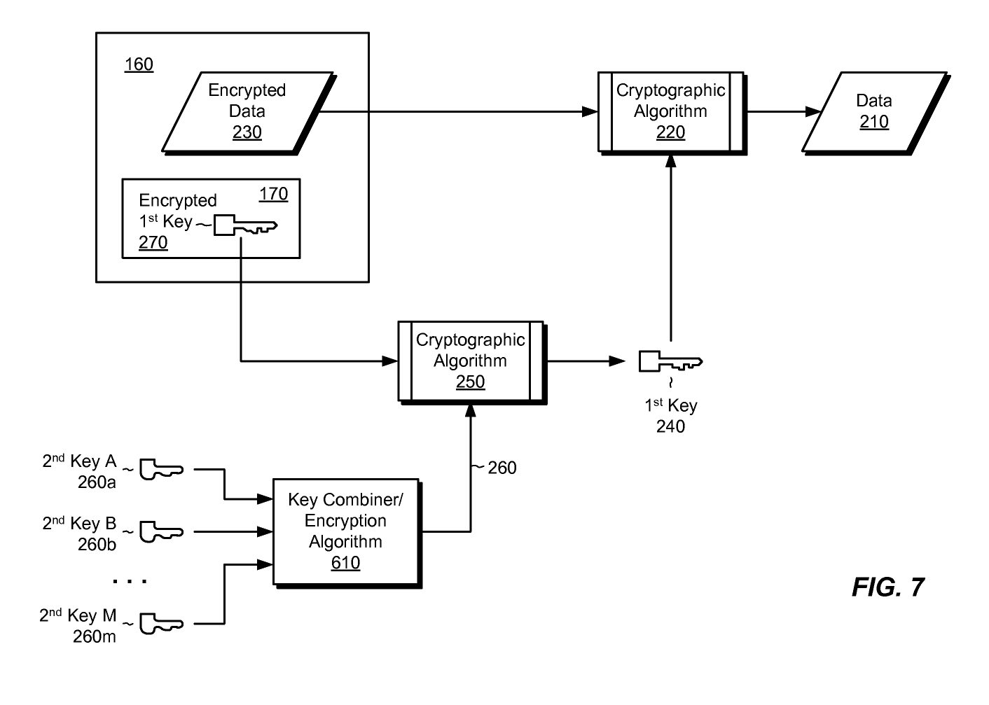

FIG. 7 shows an example data flow for unlocking encrypted data on a piece of media using multiple sub-keys. Here, the key combiner/encryption algorithm 610 receives each of the sub-keys 260a-m and combines them (e.g., via encryption and/or concatenation) to recover the second encryption key 260. The second encryption key 260 may then be applied to decrypt the encrypted data substantially as described in connection with FIG. 3 above.

The receipt of sub-keys 260a-m may be handled in a variety of ways. In one example, the computerized apparatus 110 has a user interface (not shown), and a software application running on the computerized apparatus 110 may require each person assigned a sub-key to authenticate himself or herself and enter the value of the respective sub-key. The software application may then concatenate the sub-keys 260a-m in the proper order and reconstitute the original second encryption key 260. According to some variants, persons need not be physically present at the computerized apparatus 110 to enter their sub-keys but may instead connect to the computerized apparatus 110 over a computer network, such as the Internet, for example.

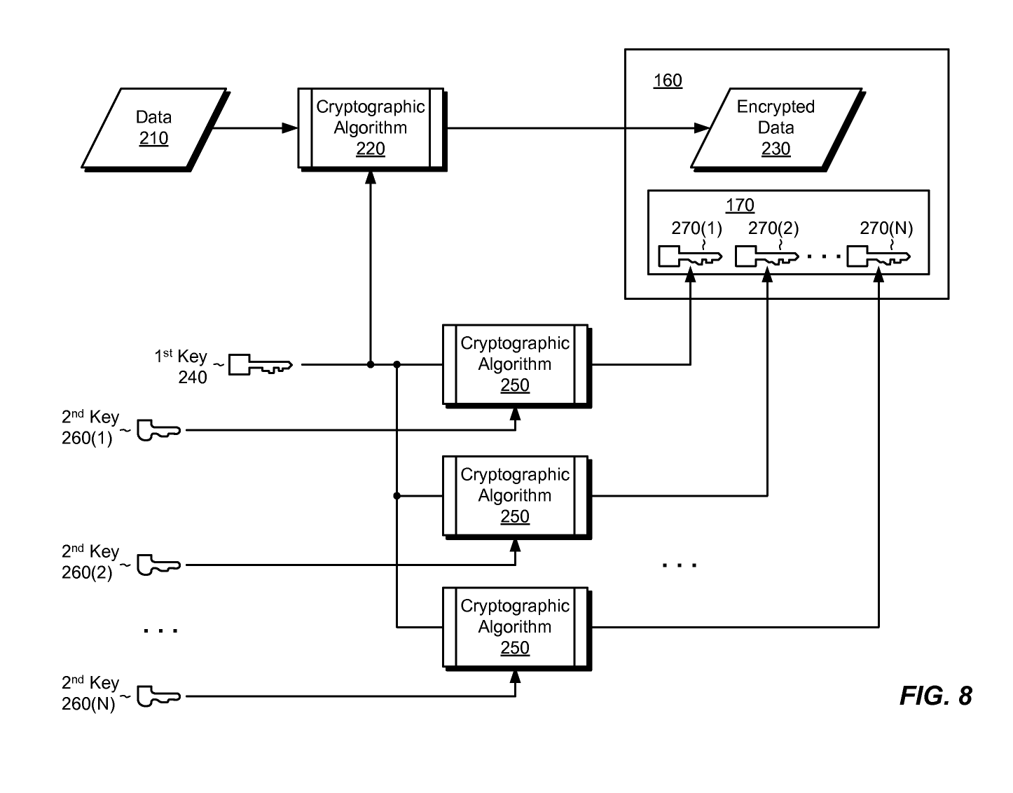

FIG. 8 shows another variant on the above-described technique for managing encryption keys. Here, multiple different second encryptions keys 260(1) through 260(N) are provided for use in generating respective encrypted first encryption keys 270(1) through 270(N) using the same first encryption key 240. The multiple second encryption keys 260(1-N) may be generated, for example, by the key generator 132 of the electronic system 100. This is not required, however, as keys may be generated in any suitable manner.

As shown in FIG. 8, the second cryptographic algorithm 250 (e.g., one instance thereof) generates a first encrypted first encryption key 270(1) from a first second encryption key 260(1) and the first encryption key 240. Similarly, the second cryptographic algorithm 250 (e.g., another instance thereof) generates a second encrypted first encryption key 270(2) from a second second encryption key 260(2) and the first encryption key 240. Other encrypted first encryption keys 260(3-N) may be generated in a similar manner. All such encrypted first encryption keys 270(1-N) are then stored on or in connection with the piece of media, e.g., in the re-writable location(s) 170 on the tape 160 (or on barcode labels, RFIDs, etc.). In an example, each of the second encryption keys 260(1-N) is sent to a different person authorized to access the piece of media. Unlike the arrangement of FIGS. 6 and 7, where all sub-keys 260a-m must be brought together to unlock the piece the media, here, each of the second encryption keys 260(1-N) is independently able to unlock the piece of media, i.e., each person receiving one of the second encryption keys 260(1-N) can access the piece of media without input from any other person.

In an example, the arrangement of FIG. 8 is particularly useful for companies and other entities that have many pieces of media in storage. In this situation, a particular second encryption key (e.g., one of 260(1-N)) is assigned to each person for unlocking all pieces of media that the respective person is authorized to access. Each person can thus unlock his or her own pieces of media using a single second encryption key. Note that the data on such pieces of media may all be encrypted with a single first encryption key 240, or different pieces of media may be encrypted with different first encryption keys 240. In either case, persons having valid second encryption keys 260(1-N) can unlock their media without regard to the first encryption key 240 used to encrypt the data, as long as the media are tagged with the proper encrypted first encryption keys 270(1-N).

In an example, one of the second encryption keys 260(1-N) is maintained as a “master key,” i.e., a key that can open any properly tagged pieces of media. For example, if the master key is chosen to be key 260(2), the key 260(2) can unlock any piece of media tagged with the encrypted first encryption key 270(2). In an example, the master key is kept as a secret and used only in extraordinary circumstances, such as when any of the second encryption keys 260(2-N) become lost, corrupted, or otherwise unrecoverable.

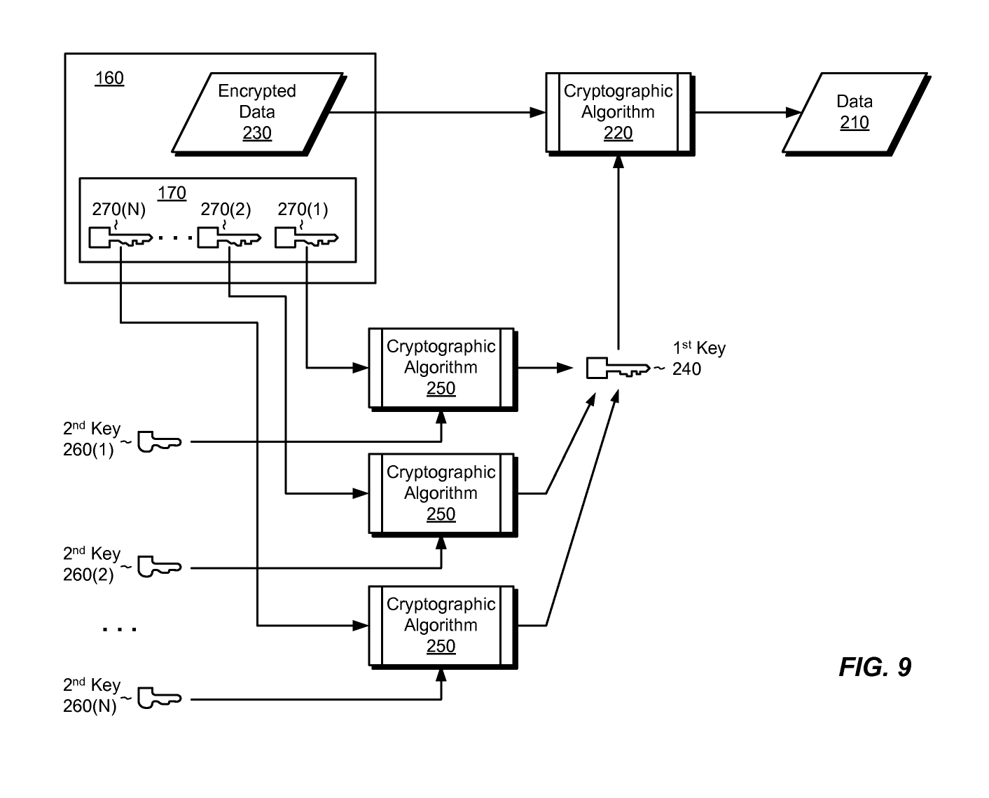

FIG. 9 shows an example data flow for unlocking encrypted data on a piece of media using any of the multiple second encryption keys. Here, any person in possession of any of the second encryption keys 260(1-N) may enter the key, e.g., into a graphical user interface (GUI), web interface, etc., of the electronic system 100. Various authentication checks may be conducted to verify the person's identity. The piece of media holding the desired encrypted data 230 (e.g., the tape 160) is loaded into the media drive 150, and the media drive 150 reads the proper encrypted first encryption key from the re-writable location 170 (or from a barcode label, RFID, etc.). For example, if the person has entered key 260(2), the media drive 150 reads the encrypted first encryption key 270(2). In some examples, the media drive 150 reads all encrypted first encryption keys 270(1-N) stored in the re-writable location(s) 170 and tries each of them. The second cryptographic algorithm 250 receives as inputs the entered second encryption key (e.g., 260(2)) as well as the corresponding encrypted first encryption key (e.g., 270(2)) obtained from the piece of media, and processes them to recover the first encryption key 240. The first encryption key 240 is then applied to the first encryption algorithm 220 to decrypt the encrypted data 230, substantially as described above in connection with FIG. 3.

It is evident that the different variants described in connection with FIGS. 1-9 may be used in any combination. For example, any of the second encryption keys 260(1-N) shown in FIGS. 8 and 9 may themselves be expressed as multiple sub-keys as shown in FIGS. 6 and 7. Also, the data flows and associated processing described in connection with FIGS. 2-4 may be regarded as an integral part of the data flows and processing described in connection with FIGS. 6-9.

Also, it is understood that the electronic system 100 may be required to access different types of media (e.g., magnetic, optical, flash memory, etc.) and that associated encrypted first encryption keys may be stored in different ways on or in connection with such media. For example, some pieces of media may store the encrypted first encryption key in one or more re-writable locations 170 of a tape, whereas others may use a particular location of flash memory, barcode labels, RFIDs, and so forth. The electronic system 100 may be equipped with a flash memory reader, barcode scanner, and/or RFID scanner to accommodate such media.

An improved technique has been described for managing encryption keys. The technique includes encrypting a set of data 210 of a piece of media (e.g., a tape 160) with a first encryption key 240, encrypting the first encryption key 240 with a second encryption key 260, and storing the encrypted first encryption key 270 on or in connection with the piece of media 160. Encrypted data may be recovered by receiving the encrypted first encryption key 170 from the piece of media 160, receiving the second encryption key 260 (e.g., from a user to whom the key is assigned), recovering the first encryption key 240 using the second encryption key 260, and decrypting the encrypted data 230 from the piece of media 160 using the first encryption key 240.

The improved technique simplifies key management because it avoids distributing keys that are capable of directly unlocking media. Rather, the first encryption key 240 may be kept as a closely guarded secret. The overall process of encrypting the first encryption key 240 and storing the resulting encrypted first encryption key 270 on or in connection with the piece of media ensures that only persons having both the second encryption key 260 and physical access to the piece of media may decrypt the data it contains. If the second encryption key 260 is lost, stolen, or otherwise compromised, the compromised second encryption key may be invalidated almost immediately upon learning of the compromise. The encrypted first encryption key 270 may be removed/deleted from the piece of media, rendering the compromised second encryption key 260 useless for unlocking the data on the media. A new second encryption key 260 and encrypted first encryption key 270 may be issued, and the media may be tagged with the new encrypted first encryption key 270, thereby restoring authorized access to the data.

The improved technique also affords companies and other entities a great deal of flexibility in controlling access to media by different persons. For example, the entity can prohibit a particular person from accessing a particular piece of media by ensuring that the encrypted first encryption key 270 stored on or in connection with that piece of media does not work with the second encryption key 260 assigned to that person. In cases such as shown in FIGS. 8 and 9, different values of second encryption keys 260(1-N) may be provided for different persons or groups of persons in an organization. With different groups having different second keys, access to media may be granted based on group and may thus reflect any desired hierarchy of access that the entity wishes to enforce.

As used throughout this document, the words “comprising,” “including,” and “having” are intended to set forth certain items, steps, elements, or aspects of something in an open-ended fashion. Also, as used herein and unless a specific statement is made to the contrary, the word “set” means one or more of something. Although certain embodiments are disclosed herein, it is understood that these are provided by way of example only and the invention is not limited to these particular embodiments.

Having described certain embodiments, numerous alternative embodiments or variations can be made. For example, the techniques hereof have been described in connection with media kept at a storage facility, such as a tape vaulting facility. However, this is merely an example. The techniques hereof may be employed in any suitable context, such as by a company or other entity for storing its own data internally.

Also, the electronic system 100 has been shown and described as including a computerized apparatus 110 that performs numerous functions. However, such functions may be distributed among multiple computerized apparatuses. Such computerized apparatuses may be located at a single site, or they may be distributed, e.g., over a network.

Also, the techniques described herein have been presented as a comprehensive approach to encryption key management. This is merely an example, however. Alternatively, the disclosed techniques may be used as secondary, redundant, backup, or supplemental approaches to key management. Therefore, it should not be assumed, nor is it necessary, that the above-described techniques are exclusive of other techniques for managing encryption keys or more generally for managing access to media.

Further, although features are shown and described with reference to particular embodiments hereof, such features may be included in any of the disclosed embodiments and their variants. Thus, it is understood that features disclosed in connection with any embodiment can be included as variants of any other embodiment, whether such inclusion is made explicit herein or not.

Further still, the improvement or portions thereof may be embodied as a non-transient computer-readable storage medium, such as a magnetic disk, magnetic tape, compact disk, DVD, optical disk, flash memory, Application Specific Integrated Circuit (ASIC), Field Programmable Gate Array (FPGA), and the like (shown by way of example as media 450 and 550 in FIGS. 4 and 5). Multiple computer-readable media may be used. The medium (or media) may be encoded with instructions which, when executed on one or more computerized apparatuses or other processors, perform methods that implement the various processes described herein. Such medium (or media) may be considered an article of manufacture or a machine, and may be transportable from one machine to another.

Those skilled in the art will therefore understand that various changes in form and detail may be made to the embodiments disclosed herein without departing from the scope of the invention.

What is claimed is:

1. A method of managing encryption keys for data stored on data storage media, comprising:
obtaining a set of data;
encrypting the set of data with a first encryption key to generate a set of encrypted data;
encrypting the first encryption key with a second encryption key to generate an encrypted first encryption key;
storing the set of encrypted data on a piece of data storage media; and
storing the encrypted first encryption key on or in connection with the piece of data storage media.

2. The method of claim 1, further comprising providing the second encryption key to one or more persons authorized to access the set of data.

3. The method of claim 2, wherein the piece of data storage media includes a re-writable location, and wherein storing the encrypted first encryption key on or in connection with the piece of data storage media includes writing the encrypted first encryption key to the re-writable location of the piece of data storage media.

4. The method of claim 2, wherein storing the encrypted first encryption key on or in connection with the piece of data storage media includes rendering the encrypted first encryption key on an identifier affixed to or otherwise placed in relation to the piece of media such that the identifier is associated with the piece of media.

5. The method of claim 4, wherein the identifier includes a label, and wherein rendering the encrypted first encryption key on the identifier includes applying a barcode of the encrypted first encryption key to the label.

6. The method of claim 4, wherein rendering the encrypted first encryption key on the identifier includes providing the identifier in the form of an RFID tag encoding the encrypted first encryption key.

7. The method of claim 2, further comprising:
encrypting each of multiple sets of data with a respective first encryption key to produce multiple sets of encrypted data each encrypted with a different first encryption key;
applying a second encryption key to encrypt each of the different first encryption keys to produce multiple encrypted first encryption keys each derived from a different first encryption key and the same second encryption key; and
for each set of encrypted data, (i) storing the set of encrypted data on a respective medium and (ii) storing the encrypted first encryption key used to encrypt the set of encrypted data on or in connection with the respective medium.

8. The method of claim 7, further comprising distributing the second encryption key to multiple persons.

9. The method of claim 2, further comprising:
storing the first encryption key in a location separate from the piece of data storage media;
generating a new encrypted first encryption key from the first encryption key and a new second encryption key;
providing the new second encryption key to one or more persons authorized to access the set of data;
deleting the encrypted first encryption key previously stored on or in connection with the piece of data storage media; and
storing the new encrypted first encryption key on or in connection with the piece of data storage media.

10. The method of claim 9, further comprising generating new encrypted first encryption keys from respective new second encryption keys (i) on a regular basis and/or (ii) in response to a suspected or actual theft of a second encryption key.

11. The method of claim 1, further comprising:
reading a set of encrypted data from a piece of media, the set of encrypted data being an encrypted version of a set of data;
receiving an encrypted first encryption key stored on or in connection with the piece of media, the encrypted first encryption key being an encrypted version of a first encryption key;
decrypting the encrypted first encryption key using a second encryption key to recover the first encryption key; and
decrypting the set of encrypted data using the first encryption key to recover the set of data.

12. A computerized apparatus, comprising:
a set of processors; and
memory, coupled to the set of processors, the memory storing executable instructions, which when executed by the set of processors cause the set of processors to perform a method of managing encryption keys for data stored on data storage media, the method including:
reading a set of encrypted data from a piece of media, the set of encrypted data being an encrypted version of a set of data;
receiving an encrypted first encryption key stored on or in connection with the piece of media, the encrypted first encryption key being an encrypted version of a first encryption key;
decrypting the encrypted first encryption key using a second encryption key to recover the first encryption key; and
decrypting the set of encrypted data using the first encryption key to recover the set of data.

13. The computerized apparatus of claim 12, wherein the piece of media is a tape and wherein the computerized apparatus further comprises a tape drive coupled to the set of processors,
wherein reading the set of encrypted data from the piece of media includes the tape drive reading the set of encrypted data from the tape, and
wherein receiving the encrypted first encryption key includes reading a re-writable location on the tape where the encrypted first encryption key was previously stored.

14. The computerized apparatus of claim 13, wherein the method further includes writing a new encrypted first encryption key to the re-writable location on the tape.

15. A method of managing encryption keys for use in encrypting data stored on tape, comprising:
obtaining a set of data;
encrypting the set of data with a first encryption key to generate a set of encrypted data;
encrypting the first encryption key with a second encryption key to generate an encrypted first encryption key;
storing the set of encrypted data on a tape; and
storing the encrypted first encryption key in a re-writable location on the tape.

16. The method of claim 15, further comprising:
encrypting each of multiple sets of data with a respective first encryption key to produce multiple sets of encrypted data each encrypted with a different first encryption key;
applying a second encryption key to encrypt each of the different first encryption keys to produce multiple encrypted first encryption keys each derived from a different first encryption key and the same second encryption key; and
for each set of encrypted data, (i) storing the set of encrypted data on a respective tape and (ii) storing the encrypted first encryption key used to encrypt the set of encrypted data in the re-writable location on the tape.

17. The method of claim 16, further comprising distributing the second encryption key to multiple persons.

18. The method of claim 15, further comprising:
storing the first encryption key in a location separate from the tape;
generating a new encrypted first encryption key from the first encryption key and a new second encryption key;
providing the new second encryption key to one or more persons authorized to access the set of data;
deleting the encrypted first encryption key previously stored in the re-writable location on the tape; and
storing the new encrypted first encryption key in the re-writable location on the tape.

19. The method of claim 18, further comprising generating new encrypted first encryption keys from respective new second encryption keys (i) one a regular basis and/or (ii) in response to a suspected or actual theft of a second encryption key.

20. The method of claim 15, further comprising:
reading a set of encrypted data from a tape, the set of encrypted data being an encrypted version of a set of data;
reading an encrypted first encryption key from a re-writable location on the tape, the encrypted first encryption key being an encrypted version of a first encryption key;
decrypting the encrypted first encryption key using a second encryption key to recover the first encryption key; and
decrypting the set of encrypted data using the first encryption key to recover the set of data.
